(19) United States
(12) Patent Application Publication
(10) Pub. No.: US 2011/0172907 A1
(43) Pub. Date: Jul. 14, 2011

(54) GUIDANCE, NAVIGATION AND INFORMATION SYSTEM ESPECIALLY ADAPTED FOR BLIND OR PARTIALLY SIGHTED PEOPLE

(75) Inventor: Diamantino Rui Da Silva Freitas, Porto (PT)

(73) Assignee: UNIVERSIDADE DO PORTO

(21) Appl. No.: 13/001,970

(22) PCT Filed: Jun. 29, 2009
(86) PCT No.: PCT/PT09/00036

§ 371 Date: Mar. 22, 2011

(30) Foreign Application Priority Data
Jun. 30, 2008 (PT) 104120

(51) Int. Cl. G01C 21/00

(52) U.S. Cl. 701/201

(57) ABSTRACT

The present invention concerns an orientation, navigation and information system, especially adapted for blind or visually impaired people. It is essentially a system that allows blind or visually impaired people to access information usually made available only to public transportation users visually, through posters or informative signs, or through dynamic information screens of various nature. It allows, first of all, the access to information from the outside or within private or public facilities or locations, using a conventional mobile phone (2) equipped with one or more additional communication channels, or a wireless communicator, and in second place, it allows also, simultaneously, the orientation and navigation of the system user(s), through places of interest (20), according to their instructions, using a discreet and non-obstructive system of acoustic emitters (3, 17), and using also a cell system or radio communication network (6) like Bluetooth and/or Wi-Fi and/or others, inserted in and related with the places of interest of the user (1). This allows the user to know his (her) accurate localization and can guide his (her) route. The present orientation, navigation and information system can also be used by people without visual impairment, by adapting the system, for example, to display orientation instructions visually.

### FIELD OF THE INVENTION

The present invention concerns an integrated sound orientation system that works through automatically controlled sound emitting and oral communication devices through a wireless computer, inside a cellular or WLAN network, with a communicator localization and voice orientation system for pedestrian navigation in the outside or within facilities, like transport stations or other locations.

### BACKGROUND OF THE INVENTION

The information usually available for blind or visually impaired people related with features and services offered within public or private locations, such as subway or train stations, is practically non-existent.

There are few exceptions, such as Braille information posts that appear in some transport stations, some spoken description systems that work on a specific player, sometimes called audio-guides and that are rarely found in museums, and tactile floor systems, yet to be normalized, and that are also very rarely found or partially implemented in transport stations and public pedestrian paths. Finally, there are also some information systems based on spoken messages, to alert or to give immediate information, generally connected with emergency evacuation calls, airport security and London subway “mind the gap” type alerts.

However, the indispensable orientation and navigation information in transportation or within public or private locations that allows users to be capable of fully using a service is wide and complex. For example, in transportation you can have information about destination, train stations and route. But you need to have also schedule information about transport vehicles, ships, and possible destination, as well as travel cost information.

The rest of the necessary information that may allow the use of a service is, generally, supplied visually, and it is located in different parts of train station or other buildings, and therefore it cannot be seen from every single spot within a building for obvious architectural reasons. This is the case of ticket offices. This also happens in other mandatory or essential services, like restrooms, police or security posts, medical stations, telecommunication offices, emergency equipments and emergency exits.

It is still the case of the essential information regarding personal navigation, which is necessary for people to reach their destination point, namely a boat boarding ramp, a metro platform, or any stop point. In other words, information regarding personal routes. A large number of the above mentioned information is not available on a building or facility entrance or on normal access paths for passengers or other persons, giving place to the introduction of more visual aids, called signaling, that gives directional tips and describes the services available for its users. In places with various sub-spaces or rooms, sometimes you cannot visualize some signs or other visual information. This motivates a careful study about sign location in order to facilitate navigation. More complex buildings demand thorough signaling of services or locations, such as doors, elevators or staircases.

As customers, blind and visually impaired people have strong limitations when using of inner or outer transportation or other facilities and it's services, if the information mentioned above, including navigation information, is provided to them in an easy way.

It is publicly known that under supervised training, blind or visually impaired people can use by their own means the inner or outer transport stations or other buildings or services referred above. However, the restraints to access information remain the same. In these situations blind or visually impaired people are severely limited in their rights as citizens and as users/customers of a given service.

Sound signals or acoustic lights are used to provide navigation information to blind or visually impaired people in the streets, like, for instance, sound signals attached to traffic lights. These lights, which are acoustic lights, operate autonomously in synchronization with the traffic lights. Their main disadvantage is sound pollution, which has been mitigated through the use of sound amplitude control devices, regarding the time of the day, the level of environmental noise, and also by the use of natural sounds, like the sound of birds.

Several patent applications comprise navigation support systems for blind people.

The document CN101076841 “Management and navigation system for blind” refers to the use of devices for unique identification through radiofrequency waves, such as “RFID tags”, that allow the detection of canes or reading devices placed on the leg of a person that signal the path through a communication module. In this document, the location units can also use infrared radiation or acoustic waves to locate and follow the communication module. A microphone inserted on the communication module is used to collect sound waves produced by its users, by other people and/or acoustic waves produced by a sonic or ultrasonic acoustic location device. A processor processes the microphone collected sounds and sends the processed data to a computing system or communication module for additional processing. A speaker inserted on the communication module is used to produce alert signs, instructions and other information. The microphone and the speaker can be used simultaneously with an acoustic tracking device to locate the user, using acoustic waves that allow the microphone or speaker to communicate acoustically with other acoustic sources or sensors located within a building or exterior location. The feasibility of the use of acoustic location here disclosed, without the intervention of human hearing, is strongly questionable in real environments due to the different nature of sonic acoustic waves that would cause severe interference between tracking devices, and also due to low frequency, that obstructs an effective sound coding in a treatable way by sign processing technology, and that isn't fast enough to be useful during the users route.

The document EP 1930742 “Navigation device and navigation system for blind and visually impaired people and a navigation method”, uses a GPS system to support blind people navigation. A mobile phone with radio technical interfaces may be employed. This system has enormous application obstacles within buildings or other facilities because GPS or similar signals have no coverage inside those places. The establishment of routes with a 0.5 m precision is practically unattainable, specially in exterior environments due to the well known “fading” and “multipath propagation” phenomena. This system is very similar to the one developed under EU financed project called “MORE” until 1977, that consisted in the creation of the first mobile phone GSM+GPS, equipped with differential GPS to allow tracking and navigation by impaired people.

Finally, the document KR20070089263 “Navigation system for the blind person and mobile device therewith”, refers to a GPS based system that communicates with blind people through high relief lettering or by voice.

The present patent application surpasses the previously mentioned difficulties. It uses sound sources that users can hear directly or through devices that allow them to apply their abilities in sound source localization. The orientation is possible with ordinary sound sources chosen to allow people to discern them from other environmental sounds or noise, particularly in interior or exterior environments with reverberating or sound reflex exposure.

On the other hand, this new system uses acoustic orientation, although it can also use GPS signals as a tracking system.

### SUMMARY AND ADVANTAGES OF THE INVENTION

To allow the access to essential information and personal orientation and navigation for blind or visually impaired people it is necessary to use one or more alternative means that can replace visual information.

Solving completely the main difficulties of information access regarding services and about buildings or other facilities where a service is provided, to allow its use by blind or visually impaired people and also by others, requires the integration of information and navigation resources in one practical and simple system. In this sense, it is here presented the use of a wireless personal communication device. The invention disclosed herewith offers the use of a network that covers a specific location where services are provided and the use of information is needed, combined with other networks of general coverage.

### BRIEF DESCRIPTION OF FIGURES

The following description is based on the drawings attached herein, which represent preferential realizations of the invention that, however, do not limit its scope:

FIG. 1: Represents the systems architecture;

FIG. 2: Example of one of the invention specific applications.

### DETAILED DESCRIPTION OF THE INVENTION

The personal communication device, also called mobile terminal, can be a mobile phone, such as the ones which are used for mobile voice or data communication through a network of specialized base stations, like “Global system for mobile communication—GSM”, “Personal Communication System—PCS” or “Universal Mobile Telecommunication System—UMTS”. However, any other type of wireless communicator, capable of offering audio bi-directional communication can be considered in the present invention, with the necessary adaptations needed for the system. The use of local networks of distributed elements, of conventional types that exist in the marketplace is an important characteristic of the present invention.

Any type of local wireless networks can be used and the radiations used can reach without difficulties every single point of the location in cause, with proper coverage and with enough bandwidth to allow human audio communication between the mobile terminal and the network infrastructure. One additional characteristic to fill by the eligible local networks to be a part of the present invention is the capability of offering the mobile terminal's location, as we will explain ahead.

Besides the audio communication capacity, the communicator can have other human interfaces that allow to activate or deactivate the audio communication tools, as well as the transmission of simple information, through a standard telephone keyboard.

A second component of the present invention is a system of acoustic emitters or sound producing devices like loudspeakers or “buzzers”, assembled inside buildings or facilities, accordingly to user orientation objectives. Sound orientation is an intrinsic human skill, connected with the ability to determine the origin and direction of sounds. There are published studies about the use of human hearing capacity to locate sound sources and its use in virtual reality environments. Using headphones we can simulate the origin of a sound and of its direction. This use is however prejudicial to blind or visually impaired people mobility in real life environments because it deprives them of hearing environmental sounds, that are essential for their orientation. In this invention, extensive tests were performed to characterize human sound orientation abilities in interior and exterior environments. The results demonstrated an excellent average quality related with punctual sound source orientation. Sound source localization was analyzed both azimuthally and in elevation variation. Concurrently, the types of sounds to use in human orientation were chosen, with the conclusion that the most effective and desirable sounds are transitional sounds as well as wideband sounds, such as chirps, short noises or percussion sounds. From the performed studies, we have confirmed the practical viability of human sound orientation in the present invention. The dynamic use of punctual sound sources for orientation, in which the user travels approaching the sound source has been also deeply analyzed, and we have confirmed its usefulness in the present situation.

For people without visual impairments, besides audible sound waves, the idea to offer space reference points on demand at a precise moment, offered in the present invention, can also become a reality with the use of other means besides sound, namely by the use of visible lights, that replace sound sources.

The use of sound sources for orientation during a route in the present invention is made with complete control by this system. The activation of a determined sound is automatically done only when the system chooses it to be appropriate for correct guidance and navigation, following the route defined previously at the user request. Some sound sources can be omnidirectional and some others directional, accordingly to the local natural environment or building characteristics, and the proximity of target points to be acoustically signaled.

The third component of the present invention is a system of cells or radio communication network, of the Bluetooth type, and/or Wi-Fi and/or others, implemented and related with locations of information interest. It is the local wireless network mentioned above. It is a network built with market available technology. Through this network the mobile terminal can access the system and use the communication channels that it offers. The mobile terminal's location will be generally ensured by the same network. It can also be ensured by a specific network based on a different type of technology when that is convenient. The connectivity between the data Access points (DAP—“data access points”) of this wireless local network will be ensured by a wire network of Ethernet or similar type or by another wireless network intended only for transport. This transport network is managed by a conventional “switch”. The wireless network can be designed to ensure continuous “seamless” cell coverage, or composed by a set of separate cells without overlapping coverage. In the first case the system will function by cell “handoff”. In the second case the system will work discontinuously, with the continuity of the process given by the central system.

The invention is based also on the location of the user's mobile terminal. The location system is the fourth component of this invention. It is external, available in the market. It should ensure the information feed with the adequate precision of the mobile terminal position, in order to not jeopardize the system's security. There are systems based on the mobile terminal's collection of information regarding the signal characteristics received from the data access points or network knots. Other systems are based in the information collected by the wireless network regarding the mobile phone terminal emission signals. These technologies are based in the recognition of radiation field patterns in the specific place in question. This component assures the supply of geographically determined information, that is used to determine the actual routing situation of its user and his mobile terminal. In some cases the mobile terminal that is destined to localization may be different from the mobile terminal destined to communicate. With the continuous technological evolution, the market terminals have a tendency to offer a larger integration of an increasing number of air interfaces. We should mention that the mobile terminal can be replaced by a specific device of the TAG type or bracelet.

Intrinsically connected with the location is the mobile terminal identification. Therefore, the mentioned component ensures an exact identification, based on codes and unique identification passwords of conventional nature in the system, such as medium access control address (MAC), or others.

The automatic localization of the user can be performed by GPS, by other GNPS, by WLAN or in WMAN or another cell network. It can also be performed by infrared, ultrasounds or RFID—Radio Frequency Identification.

The fifth component of the present invention is the operation control and user dialogue control system. This system is based in a set of computers connected in a network. The network can be of Ethernet type, wireless, or event Internet, as long as it ensures the necessarily low latency needed for the system to operate on time. The adopted metaphor regarding the system operation is the one of an interactive help-desk phone service with dynamic information and routing services. The user dials a short phone number of the local or global network and is hosted by the service. When the mobile phone terminal joins the network, the system can perform an automatic welcome note and to present itself to the user and give initial operating instructions. In other occasions, the system can provide alerts to the registered user through a phone call, giving him by audio a new information that may have just appeared in the screen of the train station, or boarding deck. The operation is guaranteed by a dialogue management software, available in the market, from the Interactive Voice Response (IVR) type. Together with this, two other sets of software assure: the telephone service/call management and trunks and information service. The dialogue management system consults also the previously described location device and sends an order for the guidance sound system production component, also above described during user routing.

The dialogue management system is designed to allow the user a secure and trustworthy experience through the use of clear but concise dialogs, sending confirmations and asking other to the user in the key points of the decision process, as well as during the routing/navigation. This system possesses a dedicated memory for each user, in a way that allows him to re-use the information from previous routes, at the user's request, as well as to adapt different types of dialogue according to specific objectives, namely by shortcutting certain steps when the users behavior is predictable. Whenever, by any reason, a call is interrupted, in the next call, if that is the user's choice, the system resumes dialog from the point where the interruption took place. The dialog system works through the audio communication system of the mobile phone terminal through a synthesized speech converting module TTS-“text-to-speech”. The phrases are carefully chosen to be simple, clear, and understood by as large a number of persons as possible. For data input and user command, the invention uses two system in parallel: an automatic speech recognizer (ASR)), speaker independent, and a two tone multi-frequency keyboard pressure recognition system (DTMF—“dual-tone multi-frequency”). This parallel use allows the user to employ his (her) speech with commodity in order to dialogue with the system or, alternatively, the option to make his choices through the mobile phone keys, which is very useful in intense noise situations that make voice recognition more difficult, an in cases where the user needs privacy.

The telephone service mentioned above guarantees the management of the calls received by the system from the start, verifying the access permission of the user mobile terminal, controlling also the data flow during the call and ensuring the call re-direct to the trunk channels of the dialogue management system, that by its turn is prepared to take several simultaneous calls. This service is entirely performed by a PBX (private branch exchange) type software and its operation is supported in the computer network that is a part of the operation control and user dialogue management system. Presently the telephone system uses VoIP (voice over Internet protocol) and the SIP (session initiation protocol) telephone protocol.

The telephone system can be divided at least in two sub-systems. The first is destined to the local network and the second is destined for universal access, through the public telephone system or any global coverage telephone system. While the connectivity of the first is ensured by a local computer network, the connectivity of the second is made through a conventional digital telephone access gateway for VoIP/SIP. Whenever the telephone calls directed to the system are made through a global telephone system, in a land or mobile network, for example, they will be attended by the second telephone sub-system and directed to a dialog management control system sector with information contents for guidance in outdoor spaces, mainly public places, in order to allow the travel plan and real movement of the user towards his destination point. These system features give it a citywide information coverage. To achieve orientation and navigation in outdoor public routes, the system can track the user using a GPS (global positioning System) or similar, attached to the mobile phone terminal, or that is a part of it, for the transmission of geographical coordinates and other related information. Alternatively, the user can supply the system geographical or street information that allow his localization in a citywide geographical reference system, for example: the user supplies information by voice or DTMF to the dialogue management system, regarding his destination. From this point, the system will produce a pedestrian or mixed (if others means of transportation are involved) route. This route is calculated and communicated to the user in an adequate manner, so that he can save it for later use. The user navigation in spaces that are not covered by the orientation and local navigation network can turn to other orientation tools such as electronic compasses attached to the mobile phone.

It must be added that the interconnection between the two telephone sub-systems, through internet or intranet, allows the connection between citywide route planner and local guidance in a determined place of interest, allowing the user to have a full support guidance and orientation system. In that place of interest the system will ensure a detailed guidance, adequate, for example, to inner places or interior spaces where a GPS or similar system cannot work with the needed stability. In conclusion, this invention is a navigation and guidance system ready for outside and inside spaces. Another feature in which this invention is different from the current state of the art, is that it can replace the outer spaces extrapolation guidance technique for inside environments, that is performed by an electronic compass and gyroscope in some of the GPS navigation systems, for a local guidance system appropriate to operate in pedestrian performed routes.

The mentioned information service is an essential part of this invention, because all the information related to places of interest depends on it, as well as the history and records of the system use and user information. The service is designed under the form of a complex database that is accessed through local computer services or internet web-services, and it is managed by a local or Internet portal.

The place of interest can be a public transport station, a public transportation vehicle, a shopping center, a cultural, educational or leisure facility, an administrative building, a hospital, a military base or a court of law, or any other type of space of social, economic or public-administrative nature, inside or outdoors.

Exemplifying the information service for a transportation system as the subway, the system will supply the user with subway station information, if they are underground or surface stations, their inner resources or points of interest, such as ticket offices, ticket validation posts, cafeterias, restrooms, exits, and subway map. Regarding this last one, it is necessary to give information regarding subway lines, train stations, schedule, travel time, travel cost, types of tickets, boarding information, etc.

Regarding cartographical nature information in the point of interest, the information system supplies in real time the information needed for the guidance or navigation plan of the user.

The Internet portal mentioned above allows to manage, locally or from the distance, the entire system through administration web-pages with indication of the values of important variables in the system operation, allowing to apply operation parameters and intervention in case of operational need. The portal also allows the access to the system database records and its manual or automatic update.

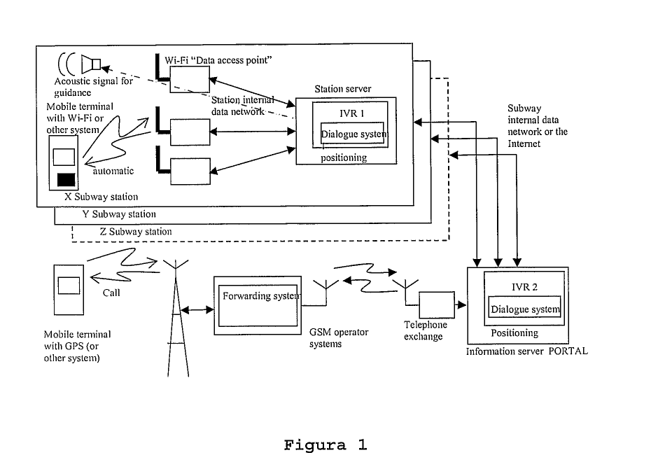

FIG. 1 represents the architecture of the system of the invention. Essentially, it shows the access to information from the outside or inside of certain public locations such as subway stations, using a GSM conventional mobile phone. Through the access of the mobile phone equipped with Bluetooth (BLT), Wi-Fi or similar, adapted with specifically designed software for it, the user can access local information of the subway station and how to get inside, for example, and he will have acoustic help combined with mobile phone aid for His orientation and navigation on foot inside the subway station. The user may also have access to operational information through a connection with the voice portal.

To orient and help the navigation inside the train station, two complementary and combined systems are created, namely a non-obstructive, discrete acoustic system, and a Bluetooth cells system implemented and related with interest spots for users.

The acoustic system is based in acoustic “signals” or “buoys”, coded and carefully located in access locations and in some areas of the subway station to support and orient, through sound location and space, the users navigation towards the points or destination that users are interested to reach.

This information is completed with spoken information given by the mobile terminal (mobile phone with BLT or Wi-Fi) and allows the user to orient himself and navigate inside the station combining the two information tools at his disposal. Phone communication can be made under a VoIP/SIP protocol.

Bluetooth cells are composed by Bluetooth Data Access Protocol (DAP) connected via Wi-Fi or ETHERNET with a specific server existing inside the station that has access to an interactive voice response system (IVR). The interactive contents of this system are contextualized for the specific part of the station where the user is.

The information can be transmitted by the access point controlling device, through the “piconet” spontaneously formed with the user mobile terminal (BLT or Wi-Fi mobile phone) as soon as the user gets close to the access point (a distance between 10 and 100 m, depending of the places). To obtain the information the user is alerted discretely of the availability of the information (vibration or paged) and, if he wishes, he can activate his connection with the dialog system by simply pressing the terminal keyboard.

The access points of BLT or Wi-Fi data, or similar, will be located in the subway station spots where it is revealed to be necessary for blind or visually impaired users to access an alternative form of existing visual information, in order for them to choose where they need to go within the station and to use the services they need (like the ticket office, for instance). The wireless communicator can be of the type Bluetooth, IEEE 802.11, Wi-Fi or HiperLAN, DECT, CDMA or OFDMA e SOFDMA, IEEE 802.16, WiMAX.

It is certain that blind users have another physical accessibility helping tools at their disposal, namely: tactile nature on the floor, Braille signals and general spoken information.

Simultaneously, a system that ensures information services outside stations can be developed, or in any other location using BLT, to guarantee the coordination between the two systems.

The previously described system can also be applied to people without visual difficulties where the user location is performed through spoken communication or through the terminal keyboard or through another interface device based on visual information regarding duly located identification elements on access points in some areas of public locations to support orientation.

### Example of Implementation

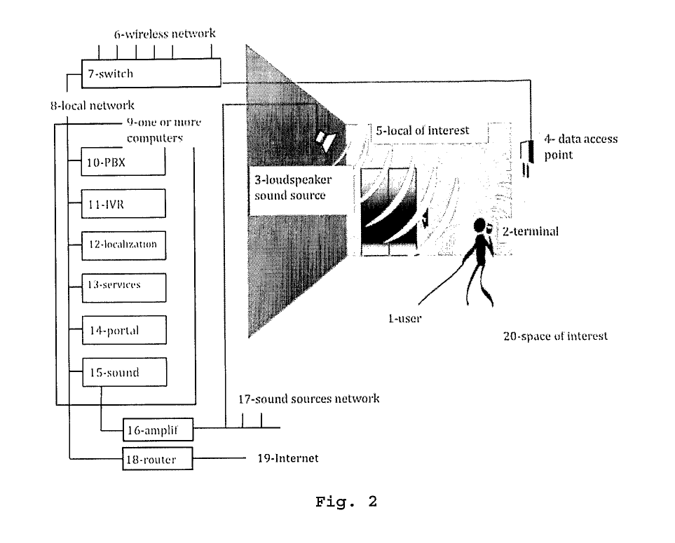

We describe hereinafter, with the aid of FIG. 2, a specific application example of this invention. We can observe in the space of interest (20) the existence of a local of interest (5), in this example an elevator door that the user (1) is trying to reach. In the space of interest (20) we can see a wireless network (6) structured through a switch (7), that groups one or more data access points (4). This wireless network can be used to audio communication or DTMF controlled by a PBX (10), between the terminal (2) of the user (1) and the system, implemented in one or more computers (9), organized on a local network (8). Alternatively, the audio communication can be performed by another telephone wireless channel, private or public. The system allows to obtain the terminal localization (2) of the user (1) through the wireless network, eventually in an articulated way with the audio communication managed by the IVR module—Interactive Voice Response—(11), in combination with a tracking module (12).

The system performance is controlled by the IVR module (11), that executes an automatic dialog process with the user (1) in which it gives him information availability options and/or personal navigation support in the space of interest (20). To place the information at user disposal the system has a local service module or distributed when connected through the internet (19) that is facilitated by a router (18). The user (1), during his personal navigation process in the space of interest (20) supported by the invention, besides the audio communication made through the terminal (2), receives in each moment, under IVR control (11), acoustic signals from a source such as a speaker (3) placed in a carefully studied way in the space of interest (20) to indicate the user (1) the precise localization of the local of interest (5) to perform his approach navigation towards the same. The sound production of the loudspeaker (3) is made of carefully studied sounds picked according to human hearing capability in sound identification and localization and it is made under the complete control of the IVR module (11) through the sound module (15), which delivers the electric signals of the sound that produces to a amplification system (16), attached to a network of sound sources (17), allowing to excite one or more sound sources at the time in every acoustic space.

1. An orientation, navigation and information system intended for use by blind or visually impaired people (1), characterized in that it enables the access to information which is usually made available to users (1) visually from the outside of or within private or public facilities or locations (20) using a mobile unit (2) comprised of a conventional mobile phone and/or a wireless communicator (6), and which includes a non-obstructive and discreet acoustic system (3, 17) and a cell system or local radio communication network (8) of the Bluetooth and/or Wi-Fi type, these being implemented in and related to the places of interest (5) in terms of useful information for the user (1).

2. An orientation, navigation and information system according to the previous claim, characterized in that the acoustic system is based in acoustic signals or beams (3), which are coded and duly positioned at the accesses to some areas of public facilities (20) so that they can support and guide, through auditory localization and spatial referencing, the navigation of users (1) towards reference points or locations (5) of said the public facilities (20) which they may be interested in.

3. An orientation, navigation and information system according to the previous claims, characterized in that to the reference information is added spoken information which will be transmitted by the mobile unit (2) and will allow the user (1) to orientate and navigate within the public facility (20) by combining the two sources of information.

4. An orientation, navigation and information system according to the previous claims, characterized in that the telephone communication takes place using a VoIP/SIP protocol.

5. An orientation, navigation and information system according to the previous claim, characterized in that the Bluetooth cells are formed by Bluetooth or Wi-Fi data access systems, which are conventionally connected by Wi-Fi/WLAN or Ethernet/LAN to, at least, one server computer (9) provided for that purpose on said public facility or in a remote location and which in its turn accedes to an interactive dialogue system with automatic response module—IVR (Interactive Voice Responder) (11).

6. An orientation, navigation and information system according to the previous claim, characterized in that it further comprises automatically controlled sound-emitting devices (17) for oral communication through the mobile unit (2), a cellular network or WLAN, with spatial localization of the mobile unit (2) and a voice information system (11), for wheelchair or pedestrian navigation outside or inside public or private facilities (20), which for that purpose uses at least one network server computer (9), a wireless radio communication network (6), a sound-emitting devices network (3, 17) and their respective amplifiers and power supplies (16).

7. An orientation, navigation and information system according to the previous claim, characterized in that the server computer (9) is provided with software for automatic call answering and searching information to be supplied to the user (1), which uses a recorded or synthesized voice system in order to transmit messages to the user, the latter being able to interact with this system by means of the mobile unit keyboard (2), via DTMF or by a switch or a scanning system or an automated speech recognition system, and of a dialogue system and its integration in the IVR (11).

8. An orientation, navigation and information system according to the previous claim, characterized in that the server computer (9) is provided with software for automatic recognition of the mobile unit of the authorized user (1) at the relevant location and which makes him/her a call to initiate the service.

9. An orientation, navigation and information system according to claim 1, characterized in that the wireless communicator (2) is of the Bluetooth-type.

10. An orientation, navigation and information system according to claim 1, characterized in that the wireless communicator (2) is of the IEEE 802.11, Wi-Fi or HiperLAN-type.

11. An orientation, navigation and information system according to claim 1, characterized in that the wireless communicator (2) is of the DECT-type.

12. An orientation, navigation and information system according to claim 1, characterized in that the wireless communicator (2) is of the CDMA or OFDMA-type.

13. An orientation, navigation and information system according to claim 1, characterized in that the wireless communicator (2) or the mobile unit is of the SOFDMA, IEEE 802.16, WiMAX type.

14. An orientation, navigation and information system according to the previous claims, characterized in that the user automatic tracking function is operated by GPS, or by another GNPS, or it is performed in a WLAN or WMAN or any other cellular network.

15. An orientation, navigation and information system according to the previous claims, characterized in that the user's (1) automatic tracking is carried out by using infrared or ultrasound signals.

16. An orientation, navigation and information system according to the previous claims, characterized in that the user's (1) automatic tracking is carried out by RFID—Radio Frequency Identification.

17. An orientation, navigation and information system according to the previous claims, characterized in that it can be applied to people without visual impairment, the user localization being accomplished by oral communication or by means of the unit's keyboard or another interface device based in visual information concerning identification elements which are duly positioned at the accesses to some areas of public facilities and will act as an aid to the navigation.

18. An orientation, navigation and information system according to the previous claims, characterized in that the public location is a public transport station.

19. An orientation, navigation and information system according to the previous claims, characterized in that the public location is a public means of transport.

20. An orientation, navigation and information system according to the previous claims, characterized in that the public location is a space of commercial, cultural, educational, recreational, administrative, clinical, military or legal nature.

21. An orientation, navigation and information system according to the previous claims, characterized in that the public or private location embraces any and all spaces of social, economic or political and administrative character, be it an inner or outer location.

22. An orientation, navigation and information system according to the previous claims, characterized in that the mobile unit may be replaced by a specific device such as a tag or bracelet.
